(19) United States
(12) Patent Application Publication
(10) Pub. No.: US 2014/0313741 A1
(43) Pub. Date: Oct. 23, 2014

(54) LAMP HAVING AN ANNULAR LIGHT-GUIDING BODY

(71) Applicant: Tai-Yin Huang, (US)

(72) Inventors: TSENG-BAO SUN, TAICHUNG CITY (TW); JR-JIE WANG, NEW TAIPEI CITY (TW)

(73) Assignee: Tai-Yin Huang, Macungie, PA (US)

(21) Appl. No.: 13/868,255

(22) Filed: Apr. 23, 2013

(51) Int. Cl. F21K 99/00; F21V 8/00

(52) U.S. Cl. CPC F21K 9/52; G02B 6/0096
USPC 362/311.02

(57) ABSTRACT

A lamp having an annular light-guiding body includes a light-emitting diode module, a light-emitting diode substrate, a circuit board, a power supply base and a bulb. The bulb is a semi-circular casing structure. An annular light-guiding body is disposed at the edge of the bulb proximal to the power supply base. The annular light-guiding body is positioned in the direction of lateral light emission from the light-emitting diode module, and has at least one light-entering face and at least one light-exiting face. Light emitted from the light-emitting diode module enters through the light-entering face, is transmitted within the annular light-guiding body, and after refraction is emitted from the light-exiting face to increase the range of light emission angle.

### BACKGROUND OF THE INVENTION

1. Field of the Invention

The present disclosure relates to a lamp; in particular, to a lamp which uses an annular light-guiding body to increase the angle and range of light emission from a light-emitting diode module.

2. Description of Related Art

Current light-emitting diode (LED) light bulbs have the same form of power supply as incandescent light bulbs do and can be directly installed on traditional lamp sockets. However, conventional light-emitting diode light bulbs emit light in a straight direction, lighting mainly the area directly in front of the light-emitting diodes and not the area peripheral to the light-emitting diodes. For example, as shown in FIG. 1A and FIG. 1B, a conventional LED apparatus 10′ uses a circular bulb and is installed on the ceiling surface 20′ for lighting and aesthetic effects. However when the LED apparatus 10′ is coupled with the lamp base 21′ of the ceiling surface 20′, the LED chips 11′ are parallel to the ceiling surface 20′. As shown in FIG. 1B, the light source of the LED apparatus 10′ innately emits light in a straight direction with limited range of emission angle, such that light emitted by the LED chips 11′ within shines mainly on the area in front of them (namely the light source emits light in a parallel direction). The ceiling surface 20′ is unable to receive light emission from the LED chips 11′. Therefore, the ceiling surface 20′ cannot obtain the prepared light source, resulting in poor overall light emission efficiency. Even if the power or amount of LED is increased, the range of the emission angle of the LED apparatus 10′ is still prohibitively limited.

Additionally, in order to increase the range of emission angle, a conventional LED apparatus 30′ as shown in FIG. 2 uses a bulb-shaped bulb 31′. However, the injection molding procedure incurs high production and material cost, which is highly uneconomical.

Hence, the present inventor believes the above mentioned disadvantages can be overcome, and through devoted research combined with application of theory, finally proposes the present disclosure which has a reasonable design and effectively improves upon the above mentioned disadvantages.

### SUMMARY OF THE INVENTION

The object of the present disclosure is to provide a lamp having an annular light-guiding body which not only increases the range of emission angle of the light-emitting diode module, but also provides lighting for the area behind the bulb of the light-emitting diode lamp. Thusly, the disadvantage of light-emitting diode lamps to form dark areas behind themselves is effectively overcome.

The secondary object of the present disclosure is to provide a lamp structure with increased light emission efficiency.

In order to achieve the aforementioned objects, the present disclosure provides a lamp having an annular light-guiding body, including: a light-emitting diode module; a light-emitting diode substrate, for the light-emitting diode module to be integrated thereon; a circuit board, which includes at least one electric circuit and can be electrically connected to the light-emitting diode module integrated on the light-emitting diode substrate; a power supply base, which is a hollow casing and houses the circuit board; and a bulb which is roughly semi-circular in shape and has an annular light-guiding body on its edge proximal to the power supply base. The annular light-guiding body is positioned in the direction of lateral light emission from the light-emitting diode module. The annular light-guiding body has at least one light-entering face and at least one light-exiting face. The light emitted by the light-emitting diode module enters the light-entering face, is transmitted within the annular light-guiding body, and after refraction is emitted from the light-exiting face, so as to increase the range of the light emission angle of the light source.

The present disclosure has at least the following advantages. The present disclosure relating to a lamp having an annular light-guiding body not only can provide lighting for areas behind the bulb of the lamp thereby improving upon the inability of a conventional lamp to do the same, but can also improve the aesthetics of the ambience by the color produced by the annular light-guiding body.

In order to further the understanding regarding the present disclosure, the following embodiments are provided along with illustrations to facilitate the disclosure of the present disclosure.

### BRIEF DESCRIPTION OF THE DRAWINGS

FIG. 1A shows a diagram of a conventional LED apparatus in use;

FIG. 1B shows a cross-sectional view of a conventional LED apparatus in use;

FIG. 2 shows a diagram of another conventional Led apparatus in use;

FIG. 3A shows a perspective view of an assembled lamp having an annular light-guiding body according to the present disclosure;

FIG. 3B shows a partial cross-sectional view of a lamp having an annular light-guiding body in use according to the present disclosure;

FIG. 4A shows a schematic diagram (1) of an annular light-guiding body integrated with a bulb according to the present disclosure;

FIG. 4B shows a schematic diagram (2) of an annular light-guiding body integrated with a bulb according to the present disclosure;

FIG. 4C shows a schematic diagram (3) of an annular light-guiding body integrated with a bulb according to the present disclosure;

FIG. 4D shows a schematic diagram (4) of an annular light-guiding body integrated with a bulb according to the present disclosure;

FIG. 5 shows a perspective view of another embodiment of an assembled lamp having an annular light-guiding body according to the present disclosure;

FIG. 6A shows a schematic diagram (1) of another embodiment of an annular light-guiding body installed on a bulb according to the present disclosure;

FIG. 6B shows a schematic diagram (2) of another embodiment of an annular light-guiding body installed on a bulb according to the present disclosure;

FIG. 6C shows a schematic diagram (3) of another embodiment of an annular light-guiding body installed on a bulb according to the present disclosure; and

FIG. 6D shows a schematic diagram (4) of another embodiment of an annular light-guiding body installed on a bulb according to the present disclosure.

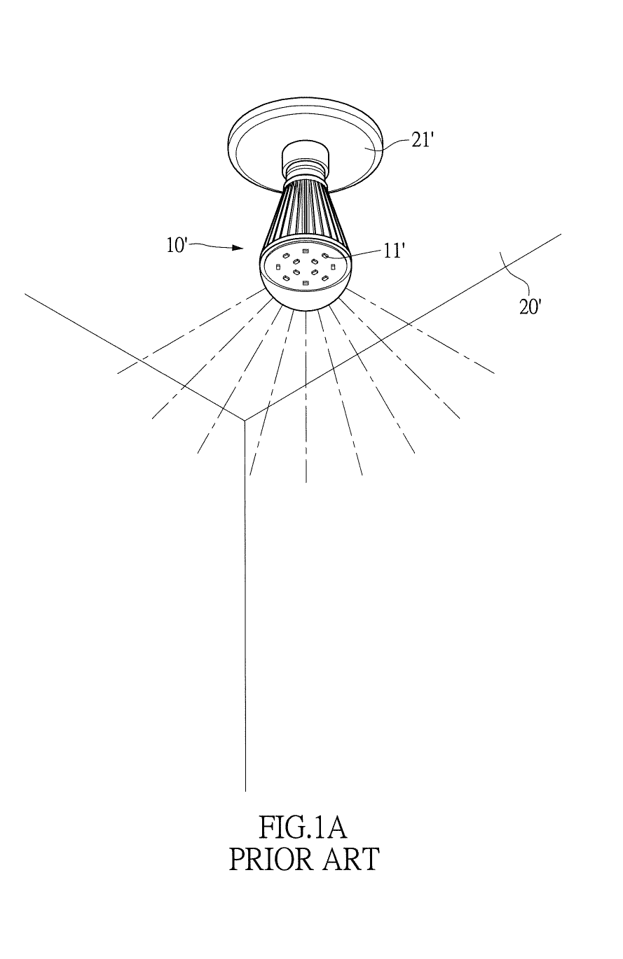

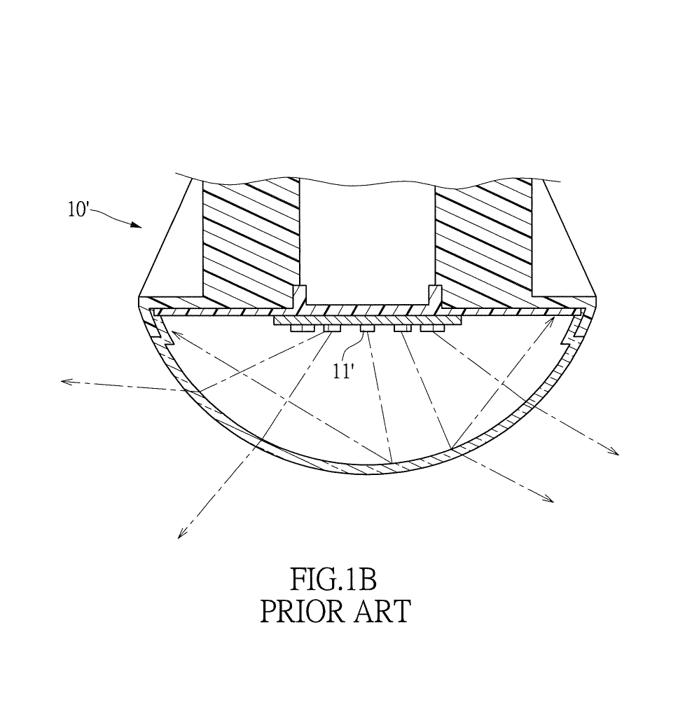

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

Unless otherwise stated, the amount and the like mentioned below do not limit the present disclosure. The lamp 1 having an annular light-guiding body of the present disclosure can be applied as ceiling lamps, recessed lighting, chandeliers, etc but are not limited thereto.

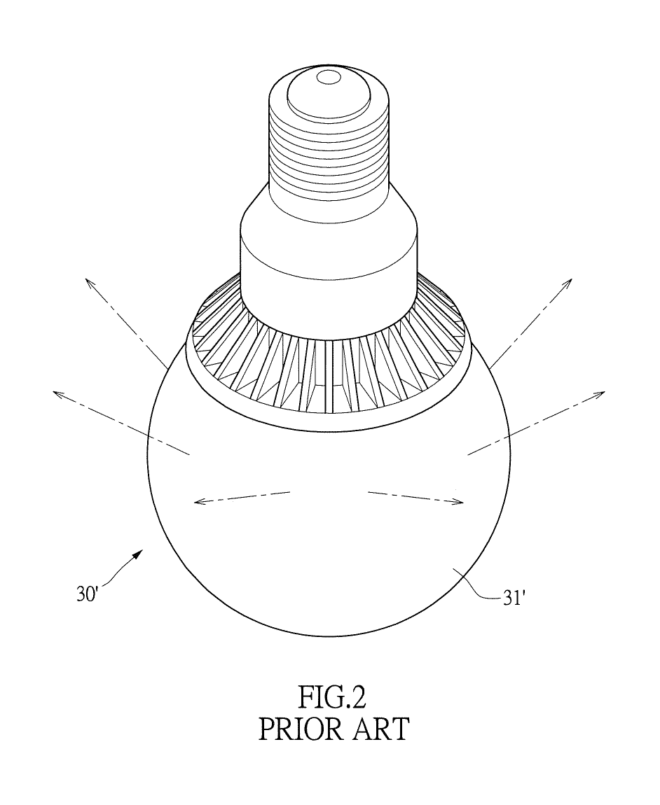

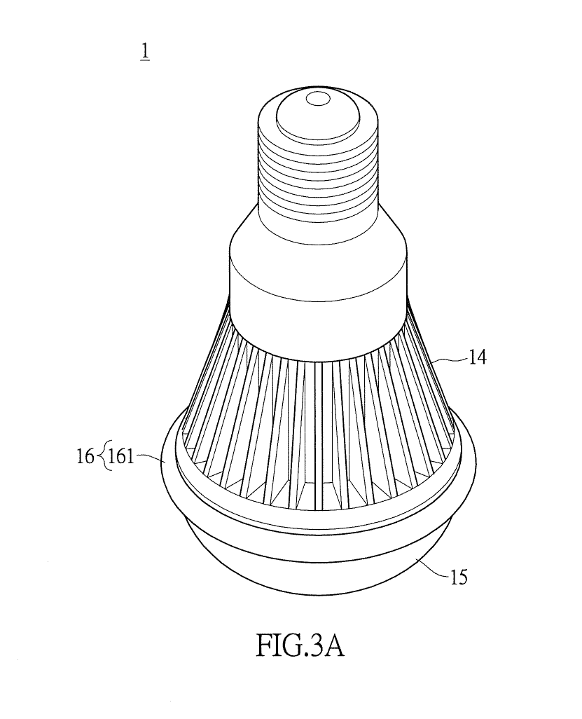

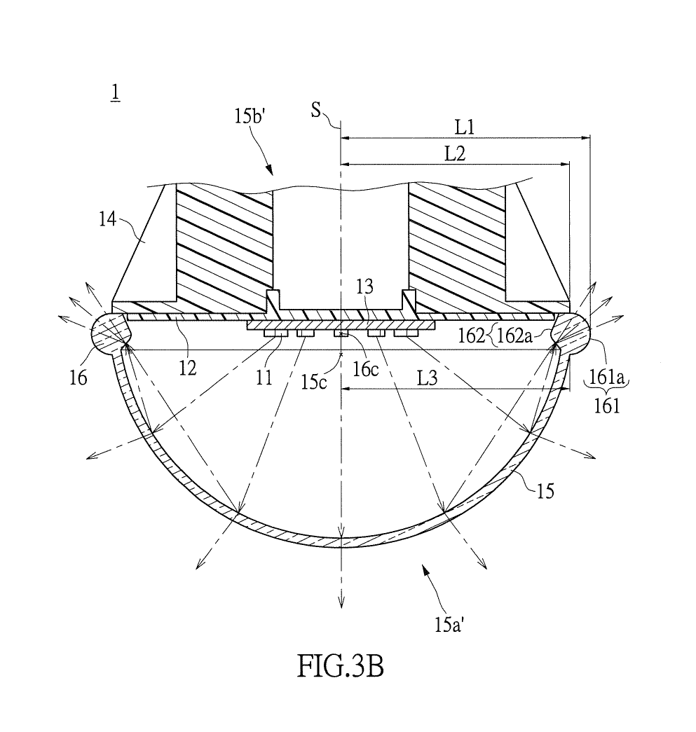

Referring to FIG. 3A and FIG. 3B, the present disclosure provides a lamp 1 having an annular light-guiding body. The lamp 1 mainly includes a light-emitting diode module 11, a light-emitting diode substrate 12, a circuit board 13, a power supply base 14 and a bulb 15. The light-emitting diode substrate 12 is provided for the light-emitting diode module 11 to be integrated thereon. The circuit board 13 includes a circuit (not shown in the figure) to be electrically connected to the light-emitting diode module 11 integrated with the light-emitting substrate 12. The power supply base 14 is a hollow casing for housing the circuit board 13 and electrically connecting to main electricity or power supplying electrical connections, such that the light-emitting diode module 11 emits light.

The bulb 15 of the lamp 1 having an annular light-guiding body of the present disclosure is a semi-circular casing structure. The bulb 15 has a front side 15a′ and a rear side 15b′. An annular light-guiding body 16 is disposed at the edge of the bulb 15 on the rear side 15b′ proximal to the power supply base 14. Given that the annular light-guiding body 16 is positioned in the direction of lateral light emission from the light-emitting diode module 11 and that the annular light-guiding body 16 has at least one light-entering face 162a and at least one light-exiting face 161a, when a user turns on the lamp 1 having an annular light-guiding body of the present disclosure such that the light-emitting diode module 11 starts to emit light, most of the light emitted by the light-emitting diode module 11 passes through the bulb 15 for lighting, and a small portion of the light emitted (laterally) from the light-emitting diode module 11 enters through the light-entering face 162a, is transmitted within the annular light-guiding body 16 and after refraction is emitted from the light-exiting face 161a, so as to increase the range of the light emission angle of the light source. By this configuration, not only can the lamp 1 having an annular light-guiding body provide lighting for the rear side 15b′ of the bulb 15 thereby improving upon the inability of a conventional lamp to do the same, but can also improve the aesthetics of the ambience by the color produced by the annular light-guiding body 16.

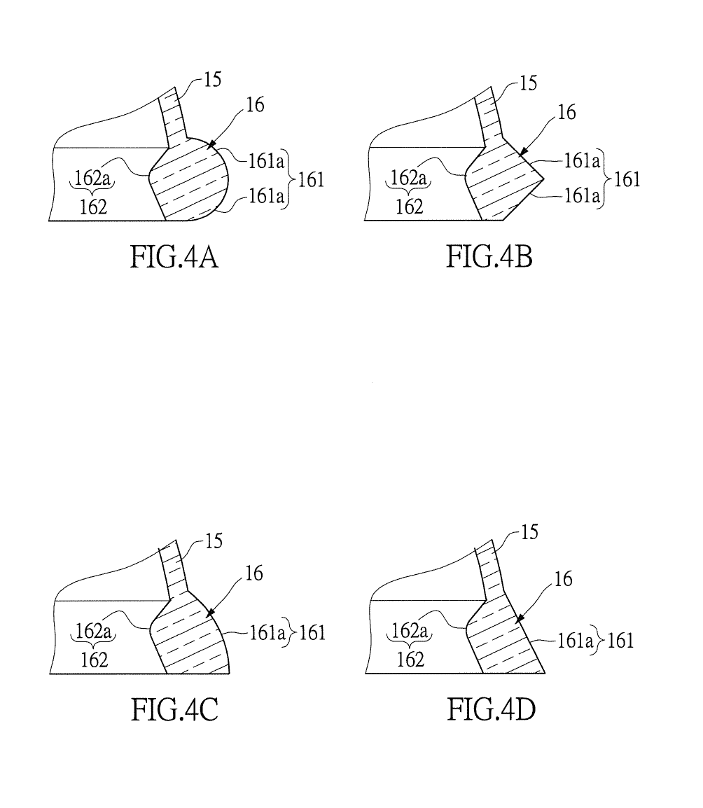

FIG. 3A shows a perspective view of an assembled lamp having an annular light-guiding body according to the present disclosure. FIG. 3B shows a partial cross-sectional view of a lamp having an annular light-guiding body in use according to the present disclosure. As shown in FIG. 3A and FIG. 3B, the lamp 1 having an annular light-guiding body includes a light-emitting diode module 11, a light-emitting diode substrate 12, a circuit board 13, a power supply base 14 and a bulb 15. The power supply base 14 is a hollow casing and expands toward the bulb 15. A plurality of spaced heat fins (not labeled) is disposed around the external side of the power supply base 14. An annular light-guiding body 16 is integrally formed on the edge of the bulb 15 proximal to the power supply base 14. The annular light-guiding body 16 includes an outer annular surface 161 and an inner annular surface 162. The outer annular surface 161 has at least one light-exiting face 161a. The inner annular face 162 has at least one light-entering face 162a. Given that the outer annular surface 161 contracts toward the power supply base 14 (FIG. 4A to FIG. 4D), the annular light-guiding body 16 can divert the light emitted from the light-emitting diode module 11 toward the rear side 15b′ of the bulb 15. In other words, the lamp 1 having the annular light-guiding body refracts light from the light-emitting diode module 11 to increase the range of the light emission angle and efficiency.

FIG. 4A shows a schematic diagram (1) of an annular light-guiding body integrated with a bulb according to the present disclosure. FIG. 4B shows a schematic diagram (2) of an annular light-guiding body integrated with a bulb according to the present disclosure. FIG. 4C shows a schematic diagram (3) of an annular light-guiding body integrated with a bulb according to the present disclosure. FIG. 4D shows a schematic diagram (4) of an annular light-guiding body integrated with a bulb according to the present disclosure. As shown in FIG. 4A and FIG. 4B, the outer annular surface 161 of the annular light-guiding body 16 contracts toward the power supply base 14 and toward the bulb 15. More specifically, the outer annular surface 161 can be pointed having two light-exiting surfaces 161a, or arc-shaped with two light-exiting surfaces 161a. Light emitted from the light-emitting diode module 11 can directly enter through the light-entering face 162a of the annular light-guiding body 16, be transmitted within the annular light-guiding body 16, and after refraction be emitted from the light-exiting face 161a toward the front and rear of the bulb 15. It is worth noting that the two arc-shaped light-exiting surfaces 161a having larger surface areas increase the angle of light emission by the annular light-guiding body 16. In other words, light emitted from the light-emitting diode module 11 can be directed at the front side 15a′ and the rear side 15b′ of the bulb 15. Additionally, as shown in FIG. 4C and FIG. 4D, the outer annular surface 161 of the annular light-guiding body 16 contracts toward the power supply base 14. More specifically, the outer annular surface 161 of the annular light-guiding body 16 is a light-exiting face 161 with a slanted face, or a light-exiting face 161 with an arc shape. Light emitted from the light-emitting diode module 11 can directly enter through the light-entering face 162a of the annular light-guiding body 16, be transmitted within the annular light-guiding body 16, and after refraction be emitted toward rear end 15′ of the bulb 15. The annular light-guiding bodies 16 of FIG. 4C and FIG. 4D have lower production costs than the annular light-guiding bodies 16 of FIG. 4A and FIG. 4B do. Therefore, the annular light-guiding bodies of FIG. 4C and FIG. 4D can reduce the production cost while achieving the object of providing lighting to the rear end of the bulb 15.

It is worth noting that that a diameter L1 of the outer annular surface 161 of the annular light-guiding body 16 is larger than a largest diameter L2 of the bulb 15, and that the diameter L1 of the outer annular surface 161 of the annular light-guiding body 16 is larger than a largest diameter L3 of the power supply base 14. Namely, the annular light-guiding body 16 is protrudingly formed between the bulb 15 and the power supply base 14. Therefore, light emitted from the annular light-guiding body 16 after refraction is less likely to be blocked by the power supply base 14, thereby increasing the range of the light emission angle and light-guiding effect. Additionally, the outer annular surface 161 of the annular light-guiding body 16 can also have complex and irregular light-exiting face 161a with multiple curves, two curves, a S-shaped curve, a regular or irregular wave-shaped curve, a jagged edge, or a successively segmented edge. When the light emitted from the light-emitting diode module 11 enters through the light-entering face 162a, is transmitted within the annular light-guiding body 16, and after refraction is emitted from the light-exiting face 161a, the light is emitted with an even distribution. The annular light-guiding body 16 can be made of a material with good light-guiding and translucent quality. The transmittance of the annular light-guiding body 16 is higher than 92%. For example, the annular light-guiding body 16 can be made of plastic, polyethylene terephthalate (PET), acrylic or glass, and formed integrally with the bulb 15 by injection molding. Obvious modifications or derivations based on the disclosure provided in the present specification and diagrams are included in the scope of the present disclosure.

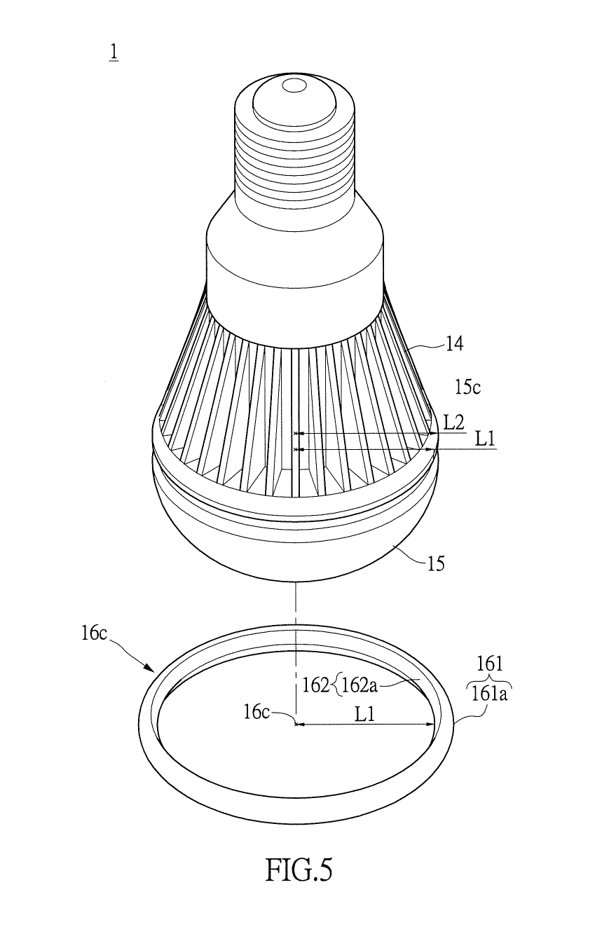

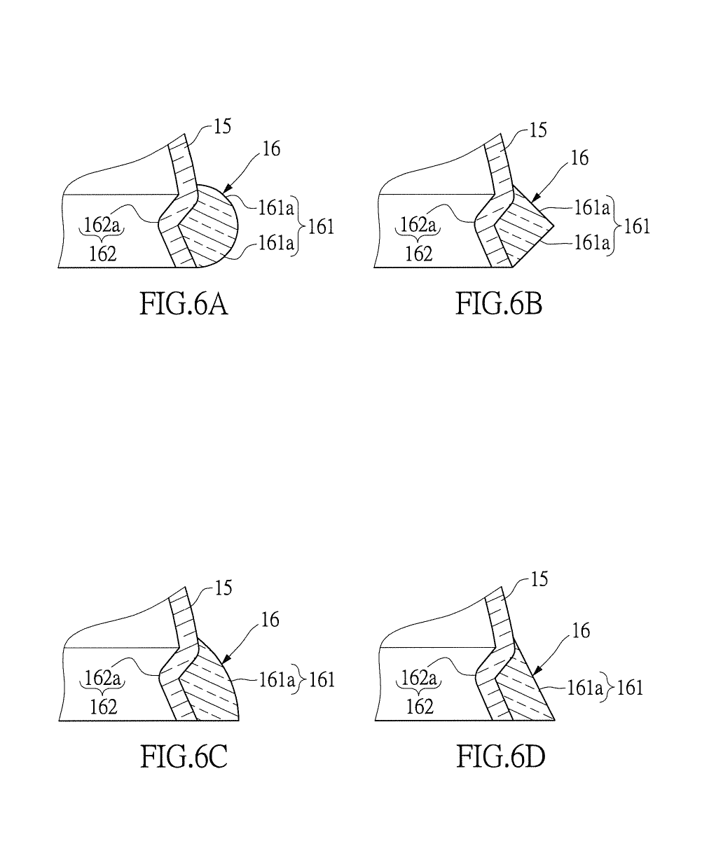

FIG. 5 shows a perspective view of another embodiment of an assembled lamp having an annular light-guiding body according to the present disclosure. FIG. 6A shows a schematic diagram (1) of another embodiment of an annular light-guiding body installed on a bulb according to the present disclosure. FIG. 6B shows a schematic diagram (2) of another embodiment of an annular light-guiding body installed on a bulb according to the present disclosure. FIG. 6C shows a schematic diagram (3) of another embodiment of an annular light-guiding body installed on a bulb according to the present disclosure. FIG. 6D shows a schematic diagram (4) of another embodiment of an annular light-guiding body installed on a bulb according to the present disclosure. As shown in FIG. 5, the difference between the present embodiment and the above embodiment lies in that the annular light-guiding body 16 is installed on the rear side 15b′ of the bulb 15 proximal to the edge of the power supply base 14. Preferably, when installing the annular light-guiding body 16 onto the bulb 15, the center 16C of the annular light-guiding body 16 and the center 15C of the bulb 15 are on the same axis (axis S) such that the light emitted from the light-emitting diode module 11, transmitted within the annular light-guiding body 16 and emitted from the annular light-guiding body 16 after refraction is evenly distributed around the lamp 1. As shown in FIG. 6A to FIG. 6D, the annular light-guiding body 16 installed between the bulb 15 and the power supply base 14 can also have an outer annular surface 161 which contracts toward the power supply base 14 and the bulb 15 (FIG. 6A and FIG. 6B), or contracts toward the power supply base 14 (FIG. 6C and FIG. 6D). Light emitted from the light-emitting diode module 11 can first pass through the bulb 15 and then enter through at least one light-entering face 162a of the annular light-guiding body 16, be transmitted within the annular light-guiding body 16, and after refraction be emitted from the light-exiting face 161a of the annular light-guiding body 16. The annular light-guiding bodies 16 of FIG. 6A to FIG. 6D have similar structures and achieved effects to those of the annular light-guiding bodies 16 of FIG. 4A to FIG. 4D, and therefore are not further described.

It is worth mentioning that the annular light-guiding body 16 can be installed on the bulb 15 by sleeving, engagement or sealing. For example, the adhesives can include welding or gluing for attaching the annular light-guiding body 16 to the bulb 15. Obvious modifications or derivations based on the disclosure provided in the present specification and diagrams are included in the scope of the present disclosure.

Additionally, it bears mentioning that the language used in the present disclosure such as up, down, left, right, front and rear merely serve reference purposes for the figures. Therefore language involving directions are used to describe and not limit the present disclosure.

The lamp having the annular light-guiding body has the following advantages. The lamp having the annular light-guiding body can direct light emitted from the light-emitting diode module and refracted from the annular light-guiding body toward the rear end of the bulb due to the contraction of the outer annular surface of the annular light-guiding body toward the power supply base. Lighting is provided on the rear end of the bulb and light emitted from the light-emitting diode module has increased range of emission angle and emission efficiency due to refraction. The lamp having the annular light-guiding body can increase the range of emission angle from the light-emitting diode module due to the contraction of the outer annular surface of the annular light-guiding body toward the power supply base and toward the bulb. The lamp having the annular light-guiding body can reduce light blocked by the power supply base due to protrusion of the annular light-guiding body from the bulb and the power supply base.

The descriptions illustrated supra set forth simply the preferred embodiments of the present disclosure; however, the characteristics of the present disclosure are by no means restricted thereto. All changes, alternations, or modifications conveniently considered by those skilled in the art are deemed to be encompassed within the scope of the present disclosure delineated by the following claims.

What is claimed is:

1. A lamp having an annular light-guiding body, comprising:
a light-emitting diode module;
a light-emitting diode substrate, for the light-emitting diode module to be integrated thereon;
a circuit board including at least one electric circuit for electrically connecting to the light-emitting diode module integrated with the light-emitting diode substrate;
a power supply base, which is a hollow casing for housing the electric circuit; and
a bulb, which is substantially a semi-circular casing having an annular light-guiding body disposed on the edge of the bulb proximal to the power supply source and in the direction of lateral light emission from the light-emitting diode module;
wherein the annular light-guiding body has at least one light-entering face and at least one light-exiting face, light emitted from the light-emitting diode module enters through the light-entering face, is transmitted within the annular light-guiding body, and after refraction is emitted from the light-exiting face to increase the range of light emission angle.

2. The lamp having an annular light-guiding body according to claim 1, wherein the annular light-guiding body includes an outer annular surface and an inner annular surface, the outer annular surface has at least one light-exiting face, and the inner annular surface hast at least one light-entering face.

3. The lamp having an annular light-guiding body according to claim 2, wherein a diameter of the outer annular surface of the annular light-guiding body is larger than a largest outer diameter of the bulb, and the diameter of the outer annular surface of the annular light-guiding body is larger than a largest outer diameter of the power supply base.

4. The lamp having an annular light-guiding body according to claim 3, wherein the annular light-guiding body is integrally formed with the bulb as one body.

5. The lamp having an annular light-guiding body according to claim 4, wherein the outer annular surface of the annular light-guiding body contracts toward the power supply base.

6. The lamp having an annular light-guiding body according to claim 4, wherein the outer annular surface has a complex and irregular light-exiting face formed by a plurality of curved faces, two curved faces, or an S-shaped face.

7. The lamp having an annular light-guiding body according to claim 4, wherein the outer annular surface is a regularly or irregularly wave-shaped face, a jagged face or a successively segmented face.

8. The lamp having an annular light-guiding body according to claim 3, wherein the annular light-guiding body is attached to the bulb.

9. The lamp having an annular light-guiding body according to claim 8, wherein the center of the annular light-guiding body and the center of the bulb lie on a same axis.

10. The lamp having an annular light-guiding body according to claim 9, wherein the annular light-guiding body is attached to the bulb by sleeving, engagement or sealing.

11. The lamp having an annular light-guiding body according to claim 8, wherein the outer annular surface of the annular light-guiding body contracts toward the power supply base.

12. The lamp having an annular light-guiding body according to claim 8, wherein the outer annular surface has a complex and irregular light-exiting face formed by a plurality of curved faces, two curved faces, or an S-shaped face.

13. The lamp having an annular light-guiding body according to claim 8, wherein the outer annular surface is a regularly or irregularly wave-shaped face, a jagged face or a successively segmented face.
